(19) United States
(12) Patent Application Publication
(10) Pub. No.: US 2026/0313225 A1
(43) Pub. Date: Oct. 8, 2026

(54) IMAGE MEASURING APPARATUS AND PROGRAM

(71) Applicant: Mitutoyo Corporation, Kawasaki (JP)

(72) Inventor: Yuki Yamasaki, Kanagawa (JP)

(21) Appl. No.: 19/634,421

(22) Filed: Mar. 31, 2026

(30) Foreign Application Priority Data
Apr. 7, 2025 (JP) 2025-063393

(51) Int. Cl. H04N 23/60; G06T 7/60; H04N 23/62

(52) U.S. Cl. CPC H04N 23/64; G06T 7/60; G06T 2207/20092; G06T 2207/30204; H04N 23/62

(57) ABSTRACT

An image measuring apparatus and a program that enable an operator to easily understand the next operation to be performed during measurement are provided. The image measuring apparatus captures an image of a measurement object, and measures the dimensions of measurement points of the measurement object by analyzing the image. The image measuring apparatus comprises: a display for displaying an image and a user interface of measurement application software used for image analysis; and a processor for executing the measurement application software. The processor identifies an operation recommended to be performed next based on the processing state of the measurement application software, and causes the display to display a textual notification of the recommended operation and a marker indicating the location for the recommended operation on the screen of the measurement application software displayed on the display.

### CROSS-REFERENCE TO RELATED APPLICATION

This non-provisional application claims priority under 35 U.S.C. §119(a) from Japanese Patent Application No. 2025-063393, filed on Apr. 7, 2025, the entire contents of which are incorporated herein by reference.

### FIELD

The disclosure relates to an image measuring apparatus that captures an image of a measurement object, analyzes the image, and measures the dimensions of the measurement points of the measurement object, and a program.

### BACKGROUND

An image measuring apparatus is a device that captures an image of a measurement object and measures the dimensions of the measurement point of the measurement object by analyzing the image (see, for example, JP2010-169584A). The image measuring apparatus performs measurements through a series of steps: specifying the elements or dimensions of interest in the captured image of the measurement object, obtaining measurement values, setting display modes and tolerances for those values, and saving the measurement results in which these settings are reflected.

### SUMMARY

### Problem to be Solved

Although various functions are implemented in the image measuring apparatus to perform the above series of measurement procedures, it is not easy for operators unfamiliar with the apparatus to understand the next operation required at each stage of measurement. In addition, while checking the instruction manual to recall forgotten functions or operations is possible, such verification tasks burden operators and reduce work efficiency.

An embodiment of the present invention has been made in view of the above problems, and an object thereof is to provide an image measuring apparatus and a program that enable an operator easy understanding of the next operation to be performed during measurement operations.

### Means for Solving the Problems

The image measuring apparatus according to an embodiment of the present invention captures an image of a measurement object, and measures the dimensions of measurement points of the measurement object by analyzing the image. The image measuring apparatus comprises: a display for displaying an image and a user interface of measurement application software used for image analysis; and a processor for executing the measurement application software. The processor identifies an operation recommended to be performed next based on the processing state of the measurement application software, and causes the display to display a textual notification of the recommended operation and a marker indicating the location for the recommended operation on the screen of the measurement application software displayed on the display.

### BRIEF DESCRIPTION OF THE DRAWINGS

FIG. 1 shows an example of the appearance of an image measuring apparatus 1.

FIG. 2 is a schematic diagram showing the internal structure of the image measuring apparatus 1.

FIG. 3 shows a functional block diagram of the image measuring apparatus 1.

FIG. 4 is a diagram showing an example of a screen displayed on display unit 6 by the measurement application software.

FIG. 5 shows an example of providing notification of recommended operations for a series of measurement operations with fixed location indications.

FIG. 6 shows an example of providing notifications of recommended operations for a series of measurement operations with the fixed location indications.

FIG. 7 shows an example of providing notifications of recommended operations for a series of measurement operations with the operation location indications.

FIG. 8 shows an example of providing notifications of recommended operations for a series of measurement operations with the operation location indications.

### EMBODIMENTS

Hereinafter, embodiments of the present invention will be described with reference to the drawings. In the following description and drawings, the same reference numeral is attached to the same functional parts, and the functional parts once explained are either omitted or explained to the extent necessary.

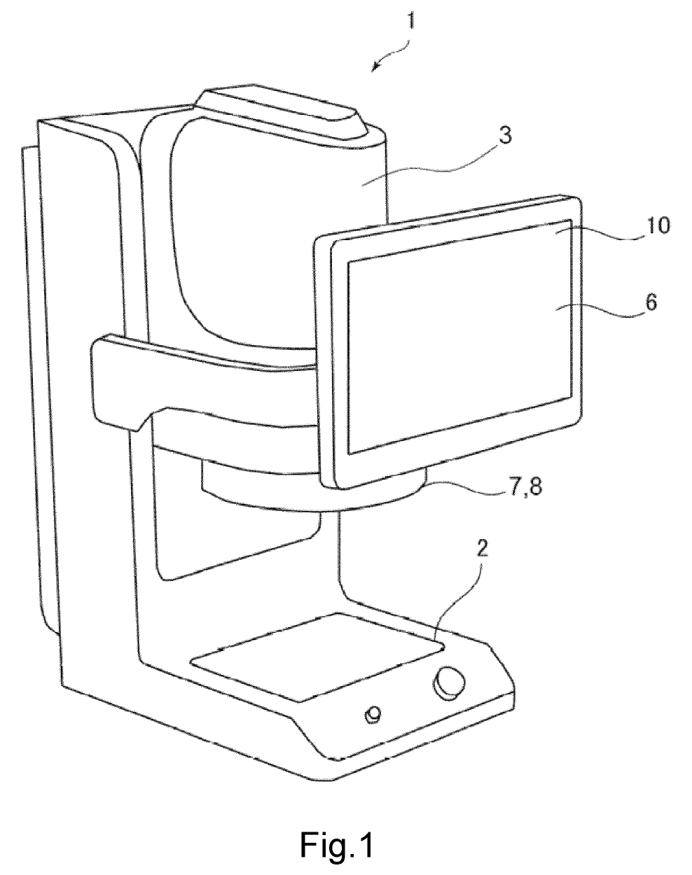

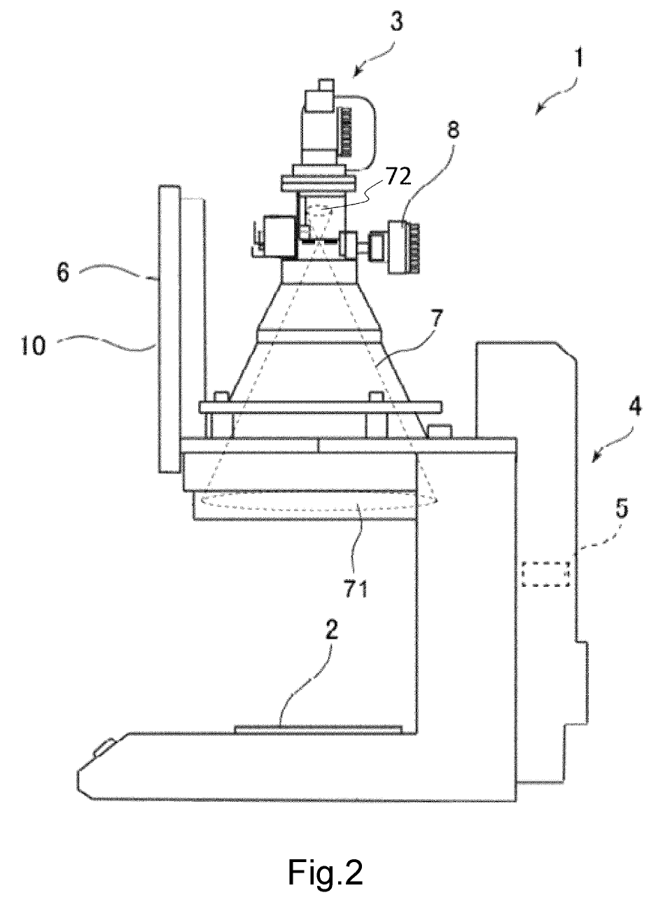

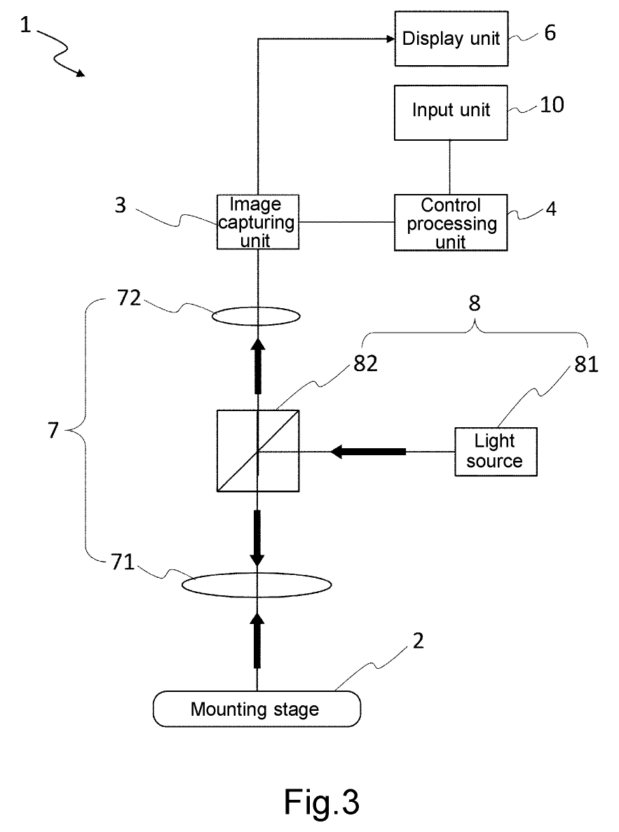

FIG. 1 is a schematic diagram showing an example of the appearance of an image measuring apparatus 1. FIG. 2 is a schematic diagram showing the internal structure of the image measuring apparatus 1. FIG. 3 shows a functional block diagram of the image measuring apparatus 1. In the present embodiment, the case in which the coaxial episcopic illumination is adopted as the illumination method will be explained as an example, but any illumination method is acceptable as long as the image of the measurement object can be captured.

The image measuring apparatus 1 includes a mounting stage 2, an image capturing unit 3, a control processing unit 4, a storage unit 5, a display unit 6, a telecentric optical system 7, an illumination unit 8, and an input unit 10.

The mounting stage 2 is a platform on which a measurement object W is placed.

The image capturing unit 3 is disposed opposite the mounting stage 2 and captures images of the measurement object W mounted on the mounting stage 2 by receiving light from the direction of the mounting stage 2. The image capturing unit 3 includes an image sensor, which converts the brightness or darkness of an image formed on its light-receiving surface into an electrical signal, thereby generating image data. For the image sensor, a semiconductor solid-state imaging device such as CCD (Charge-Coupled Device) or CMOS (Complementary Metal Oxide Semiconductor) is used.

The storage unit 5 is an arbitrary storage means capable of storing digital data.

The display unit 6 is an arbitrary display means, and displays the image of the measurement object W captured by the image capturing unit 3 etc.

The telecentric optical system 7 includes an objective lens 71 that collects light from the direction of the mounting stage 2 and an imaging lens 72 that forms an image of the light arriving through the objective lens 71 on the light-receiving surface of the image capturing unit 3. The objective lens 71 and the imaging lens 72 may have a plurality of lens surfaces, respectively.

The illumination unit 8 is a coaxial episcopic illumination means provided with a light source 81 that emits illumination light and a beam splitter 82 that interrupts the illumination light from the light source 81 into the telecentric optical system 7 and directs the light toward the mounting stage 2 as coaxial episcopic illumination light whose optical axis coincides with that of the image capturing unit 3. The illumination unit 8 may be equipped with transillumination or side illumination in addition to the coaxial episcopic illumination for image clarity and other purposes.

The input unit 10 accepts input operations by the operator. The input unit 10 may be configured as a touch panel display integrated with the display unit 6, for example. In addition, the input unit 10 may be provided with a mouse in addition to or in place of the touch panel display.

The control processing unit 4 is composed of a CPU. The control processing unit 4 controls each part in the image measuring apparatus 1 and performs necessary arithmetic processing to realize image capture and image measurement by the image measuring apparatus 1 by executing various programs. The various programs include programs describing functions to control the image capturing unit 3, the illumination unit 8, etc., and programs for the image measurement application that performs measurements such as the dimensions of various parts of the measurement object W using the image of the measurement object W captured by the image capturing unit 3. The program may be read from the storage unit 5 or from another storage medium.

Next, the measurement application software, one of the programs executed by the control processing unit 4, will be described.

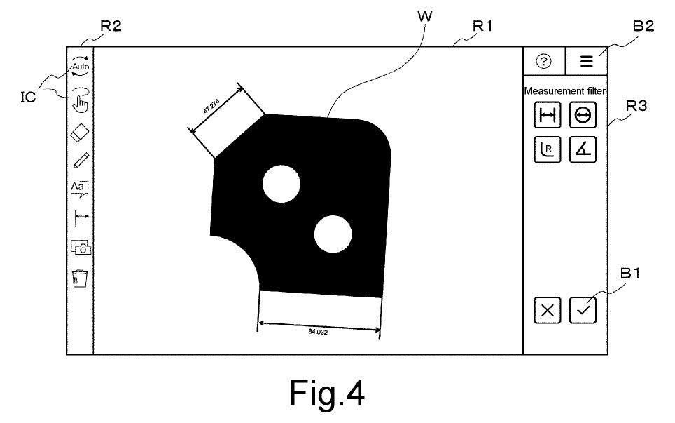

FIG. 4 is a diagram showing an example of a screen displayed on display unit 6 by the measurement application software. Camera view R1 is an area where the image captured by the image capturing unit 3 is displayed. Toolbar R2 is an area where icons for calling frequently used functions in the measurement application software are displayed. When the operator taps the icon displayed on this toolbar R2, the function corresponding to the tapped icon is executed. Option panel R3 is an area where various user interfaces necessary for measurement operations are displayed, including buttons such as the confirmation button B1 and menu button B2, slider bars, text boxes, toggle switches, etc.

Measurements using such measurement application software typically follow a series of steps: while an image captured by the image capturing unit 3 is displayed in the camera view R1, the operator specifies the elements or dimensions of interest for measurement, obtains the measurement values, sets display mode or tolerances for the measurement values, and saves the measurement results in which these settings are reflected.

In the present embodiment, the screen of the measurement application software displays a textual notification indicating the next recommended operation and a marker indicating the operation location. Hereinafter, these textual notifications and marker indications are referred to as notifications of recommended operations. In the notifications of recommended operations, the next recommended operation is identified based on the processing state of the measurement application software (e.g., the displayed image, the most recent operation performed, the selection state of elements, etc.). The textual notification and marker are then displayed according to the identified operation. The next recommended operation for each processing state is predetermined and is described within the program of the measurement application software. These notifications of recommended operations enable the operator to understand the operation they should perform next and the location of the user interface required to perform that operation.

In this embodiment, the measurement application software provides two notification methods as the notifications of recommended operations: “fixed location indications” and “operation location indications”. Operators can choose how to receive the notifications of recommended operations by configuring the measurement application software according to their preferences.

### Notifications of Recommended Operations with Fixed Location Indications

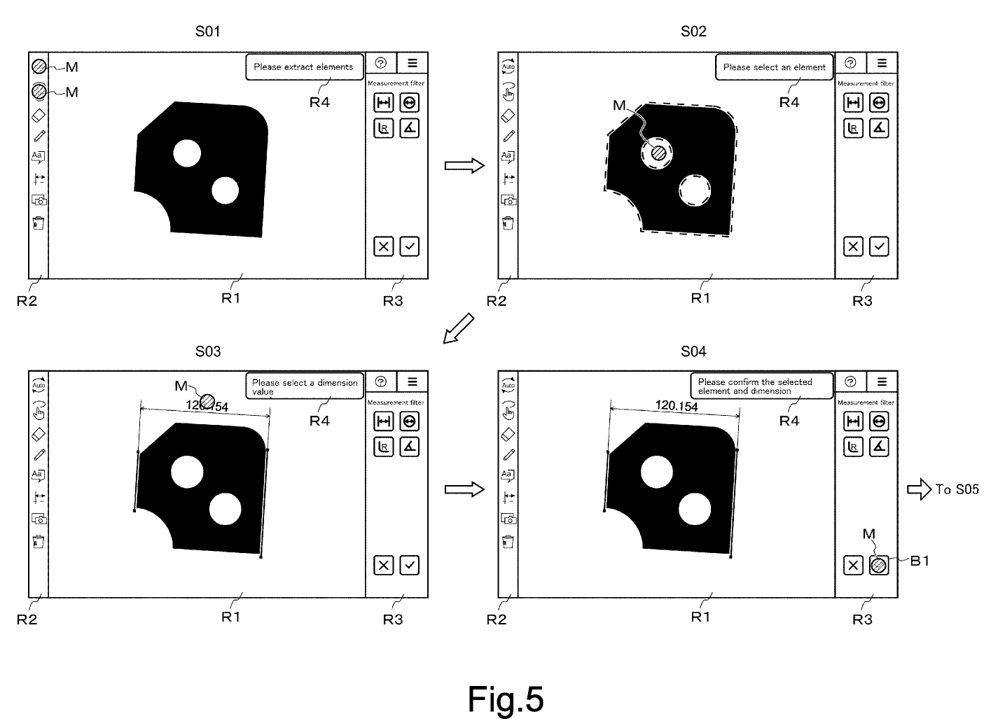

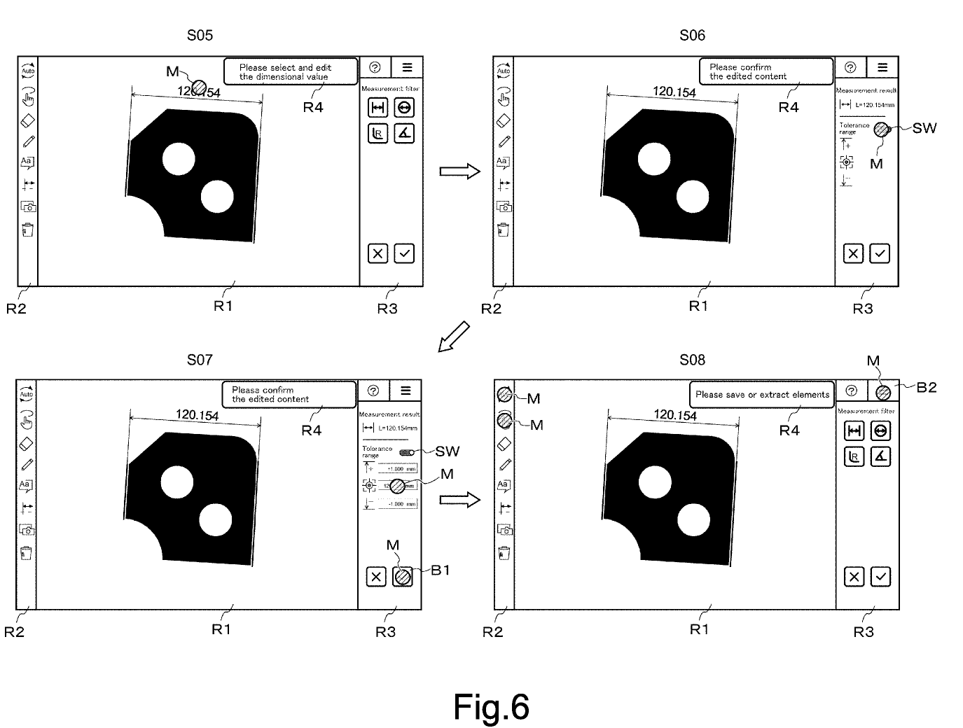

FIGS. 5 and 6 show examples of providing notifications of recommended operations for a series of measurement operations with the fixed location indications. In the fixed location indications, a notification display area R4 for displaying the textual notification is shown at a predetermined fixed location (in FIGS. 5 and 6, the upper right of the camera view R1), along with a marker M indicating the location for the recommended operation. The marker M may be displayed in a manner easily visible to the user by color, brightness, flashing, movement, or other effects. For example, the marker M may be displayed in a highly visible color at (or near) the location for the recommended operation.

In the following, a specific example of the notifications of recommended operations in the fixed location indications is explained along the series of measurement operations. When the image of the measurement object W placed on the mounting stage 2 is captured by the image capturing unit 3, the captured image of the measurement object W is displayed in the camera view R1. The recommended operation to perform next in this state where only the image of the measurement object W is displayed, is to extract elements (various geometric shapes contained within the shape of the measurement object W) from the image. Therefore, the measurement application software displays a notification stating “Please extract elements” in the notification display area R4 and displays a marker M superimposed over two icons IC on the toolbar R2 that are related to the function for extracting elements (S01 in FIG. 5). In this manner, the operation location indicated by the marker(s) in the notifications of recommended operations is not limited to one location and may be multiple locations.

When the operator performs the operation to extract elements, a shape representing the extracted elements is displayed superimposed on the image of the measurement object W in the camera view R1. The recommended operation to perform next in the state where elements have been extracted is the operation to select an element to focus on in the measurement. Therefore, the measurement application software displays a notification stating “Please select an element” in the notification display area R4 and displays the marker M superimposed on the shape representing the element displayed in the camera view R1 (S02 in FIG. 5). By analyzing the image of the measurement object W and extracting elements, the positions of elements on the image of the measurement object W are identified. This enables the marker M to be superimposed on the positions of the elements on the image of the measurement object W in the camera view R1. That is, while the display position of the marker M changes based on the captured image of the measurement object W, the marker can be displayed at a consistently appropriate position on the image, thereby prompting the user to proceed with the next operation.

Here, if multiple elements have been extracted, marker M may be displayed for all elements, or it may be displayed only for a limited number (e.g., one) of elements. For which element the marker M is displayed may be determined based on predetermined conditions (e.g., the element closest to the center of the image, the largest element in size, etc.). Alternatively, the marker M may be displayed at a position determined based on multiple elements (e.g., the center of gravity position of multiple elements). The measurement application software may continue issuing the notifications of recommended operations, similar to those in S02 in FIG. 5, until the required number and combination of elements for obtaining the measurement values (dimensional values) are selected.

When the operator selects the required number and combination of elements to obtain measurement values by tapping elements displayed in the camera view R1, the measurement application software displays the measurement values superimposed on the image of the measurement object W in the camera view R1, along with dimension lines and dimension auxiliary lines as needed. Depending on the number and combination of selected elements, multiple measurement values may be displayed. In the example shown in S03 of FIG. 5, two parallel straight line elements are selected, and the distance between them is displayed as the measurement value. In this state, the recommended operation to be performed next is selecting the measurement value (dimension value) to be recorded as the measurement result. Therefore, the measurement application software displays a notification stating “Please select a dimension value” in the notification display area R4, and displays the marker M superimposed on the measurement value shown in the camera view R1 (S03 in FIG. 5). The position where the measurement value is displayed within the camera view R1 changes depending on the selected element. However, since the measurement application software knows the display position of the measurement value, the marker M can always be displayed at the appropriate position to prompt the user for the next operation. Here, when multiple measured values are displayed, the operation locations indicated by marker M can be the display locations of all measurement values. Alternatively, the display locations of a limited number (e.g., one) of measurement values can be indicated. Which of the display locations of the measurement values to show the marker M may be determined based on predetermined conditions (e.g., the display location of the measurement value closest to the center of the image).

By tapping the measurement value displayed in the camera view R1, the operator selects the measurement value. With the measurement value selected in this manner, the recommended operation to be performed next is to confirm the element and measurement value (dimensional value) to be recorded as the measurement result. Therefore, the measurement application software displays a notification in the notification display area R4 stating, “Please confirm the selected element and dimension,” and superimposes the marker M over the confirmation button B1 displayed in the option panel R3 (S04 in FIG. 5).

By the operator tapping the confirmation button B1, the element and measurement value (dimensional value) to be recorded as the measurement result are confirmed. The recommended operation to be performed next in this state is editing dimensional information, such as tolerances, for the measurement values. Therefore, the measurement application software displays a notification in the notification display area R4 stating, “Please select and edit the dimensional value,” and displays a marker M superimposed on the measurement values shown in the camera view R1 (S05 in FIG. 6).

When the operator taps a measurement value displayed in the camera view R1, the measurement value comes under selection. The recommended operation to be performed next in this state is to select the editing content for the measurement value. Therefore, the measurement application software displays a notification in the notification display area R4 stating “Please confirm the edited content” and displays a marker M superimposed on the user interface for selecting the edit content displayed in the option panel R3 (S06 in FIG. 6). In the example of FIG. 6, the marker M is displayed superimposed on the toggle switch SW for selecting whether to enable setting a tolerance range as the edit content for the measurement value.

When the operator taps the toggle switch SW to enable setting the tolerance range, the upper and lower limits defining the tolerance range become editable. The recommended operation to be performed next in this state is to check the respective values of the tolerance range and edit them as necessary. Therefore, the measurement application software continues to display the notification “Please confirm the edited content” in the notification display area R4, while also displaying a marker M superimposed over each value of the tolerance range shown in the option panel R3 and the confirmation button B1 (FIG. 6, S07).

When the operator edits each value of the tolerance range as needed and taps the confirmation button B1, the tolerance range for the measurement value is confirmed. The recommended operation to be performed next in this state is either saving the measurement result or extracting elements from the image again to include new measurement values in the measurement result. Therefore, the measurement application software displays a notification in the notification display area R4 stating “Please save or extract elements,” and displays markers M superimposed on the two icons IC related to the function for extracting elements displayed in the toolbar R2 and on the menu button B2 at the top of the option panel R3 (S08 in FIG. 6).

When the operator performs the operation to extract elements, a shape representing the extracted elements is displayed superimposed on the image of the measurement object W in the camera view R1, resulting in a state similar to S02 in FIG. 5. Thereafter, the operator continues the measurement operation until measurement values for all desired measurement points are included in the measurement results. During the operation, the notifications of recommended operations similar to those described in S02 to S08 above are issued in response to the operator's operations. On the other hand, if the operator selects the save command from the displayed menu when pressing the menu button B2, the measurement results are saved, and the series of measurement operations ends.

According to the notifications of recommended operations in the fixed location indications described above, the operator can intuitively understand that they should perform the operation at the location indicated by the marker M to execute the content notified in the notification display area R4. This allows even operators with limited knowledge of measurement operation methods to easily grasp the operation to be performed next. As a result, measurement operations can be performed efficiently. Furthermore, by always displaying the notification display area R4 in the same position to notify the operator of the measurement operation overview, it provides the operator with a sense of security, allowing them to know the currently required task simply by looking at the fixed position.

### Notifications of Recommended Operations with Operation Location Indications

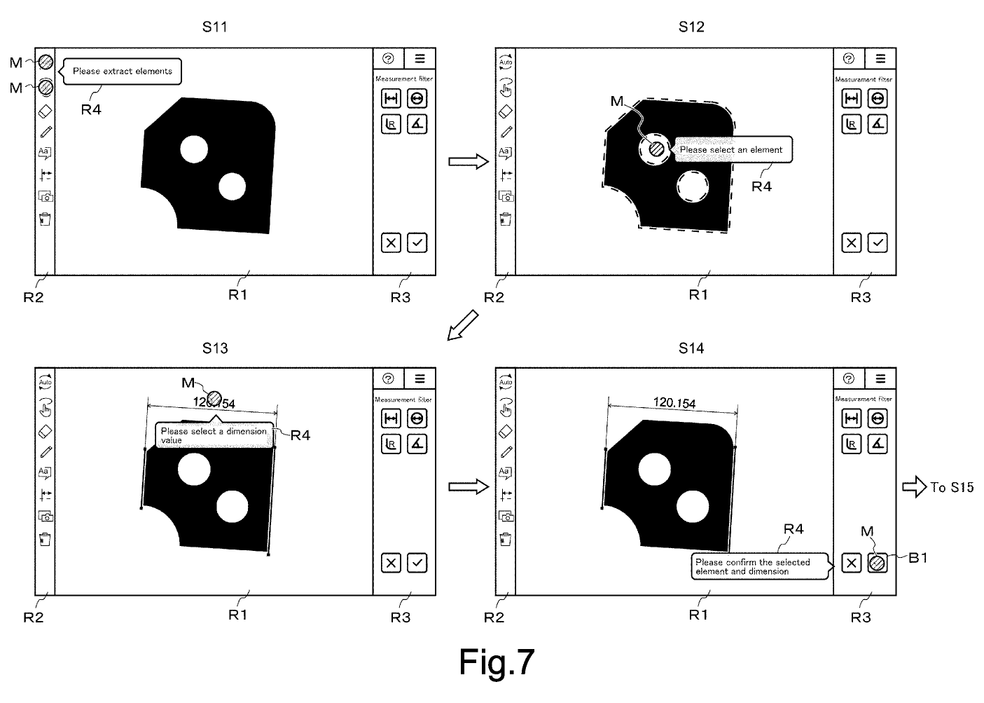

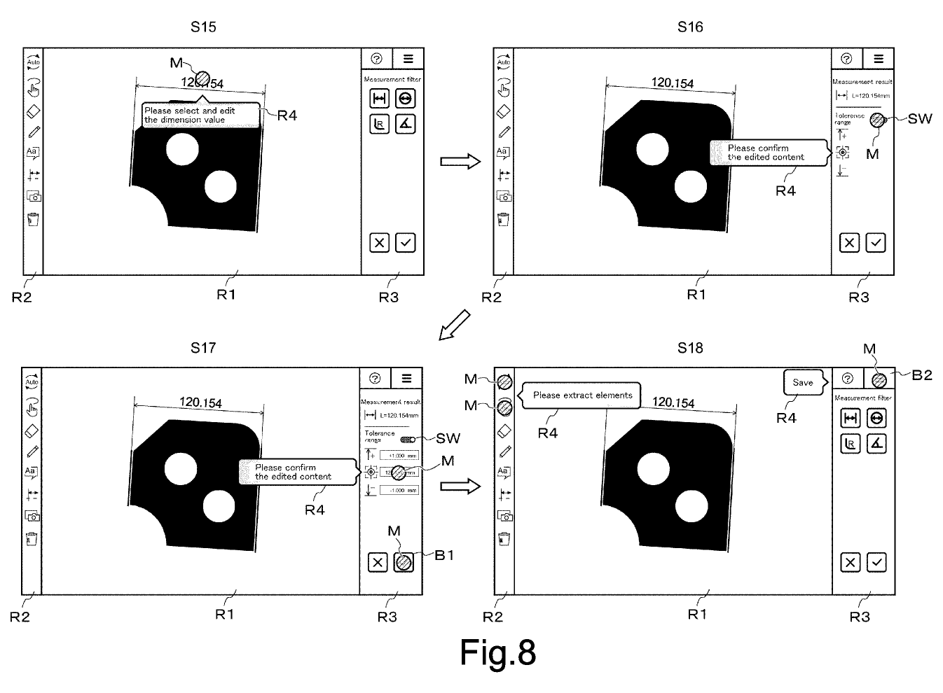

FIGS. 7 and 8 show examples of providing notifications of recommended operations for a series of measurement operations with operation location indications. In the operation location indications, the notification area R4, which provides an overview of the measurement operations, is displayed near the location for the recommended operation, along with marker M indicating the recommended operation location.

In the following, a specific example of the notifications of recommended operations in the fixed location indications is explained along the series of measurement operations. When the image of the measurement object W placed on the mounting stage 2 is captured by the image capturing unit 3, the captured image of the measurement object W is displayed in the camera view R1. The recommended operation to perform next in this state where only the image of the measurement object W is displayed, is to extract elements (various geometric shapes contained within the shape of the measurement object W) from the image. Therefore, the measurement application software displays a marker M superimposed over the two icons IC related to the functions of extracting elements from among the icons displayed on toolbar R2, and simultaneously places the notification display area R4 near these icons IC to display the notification “Please extract elements” (step S11 in FIG. 7). As shown in this example, when there are multiple locations for the recommended operations, the operation location indicated by marker M may be limited to one. In this example, the marker M is displayed at the center of gravity position of the two icons IC related to the common function of extracting elements, and the notification display area R4 is placed near the marker M. In this way, it is possible to provide the notification near the location for the recommended operation while preventing the screen from becoming cluttered with numerous notification display areas R4.

When the operator performs the operation to extract elements, a shape representing the extracted elements is displayed superimposed on the image of the measurement object W in the camera view R1. The recommended operation to perform next in the state where elements have been extracted is the operation to select an element to focus on in the measurement. Therefore, the measurement application software displays the marker M superimposed on the graphic representing the element displayed in the camera view R1, places the notification display area R4 nearby, and displays the notification “Please select an element” (S12 in FIG. 7). By analyzing the image of the measurement object W and extracting elements, the positions of elements on the image of the measurement object W are identified. This enables the marker M to be superimposed on the positions of elements on the image of the measurement object W in camera view R1, and the notification display area R4 to be superimposed in its vicinity. That is, while the display positions of the marker M and the notification display area R4 change based on the captured image of the measurement object W, the marker M and the notification display area can be displayed at a consistently appropriate position on the image, thereby prompting the user to proceed with the next operation.

Here, if multiple elements have been extracted, marker M may be displayed for all elements, or it may be displayed only for a limited number (e.g., one) of elements. The measurement application software may continue issuing the notifications of recommended operations, similar to those in S12 in FIG. 6, until the required number and combination of elements for obtaining the measurement values (dimensional values) are selected.

When the operator selects the required number and combination of elements to obtain measurement values by tapping elements displayed in the camera view R1, the measurement application software displays the measurement values superimposed on the image of the measurement object W in the camera view R1, along with dimension lines and dimension auxiliary lines as needed. Depending on the number and combination of selected elements, multiple measurement values may be displayed. In the example shown in S13 of FIG. 7, two parallel straight line elements are selected, and the distance between them is displayed as the measurement value. n this state, the recommended operation to be performed next is selecting the measurement value (dimension value) to be recorded as the measurement result. Therefore, the measurement application software displays the marker M superimposed on the measured value shown in camera view R1, and places the notification display area R4 nearby to show the notification “Please select a dimension value” (FIG. 7, S13). The position where the measurement value is displayed within the camera view R1 changes depending on the selected element. However, since the measurement application software knows the display position of the measurement value, the marker M or the notification display area can always be displayed at the appropriate position to prompt the user for the next operation.

By tapping the measurement value displayed in the camera view R1, the operator selects the measurement value. With the measurement value selected in this manner, the recommended operation to be performed next is to confirm the element and measurement value (dimensional value) to be recorded as the measurement result. Therefore, the measurement application software displays the marker M superimposed on the confirmation button B1 shown in the option panel R3, and places the notification display area R4 nearby to show the notification “Please confirm the selected element and dimension” (S14 in FIG. 7).

By the operator tapping the confirmation button B1, the element and measurement value (dimensional value) to be recorded as the measurement result are confirmed. The recommended operation to be performed next in this state is editing dimensional information, such as tolerances, for the measurement values. Therefore, the measurement application software displays the marker M superimposed on the measured value shown in camera view R1, and places the notification display area R4 nearby to show the notification “Please select and edit the dimension value” (FIG. 8, S15).

When the operator taps a measurement value displayed in the camera view R1, the measurement value comes under selection. The recommended operation to be performed next in this state is to select the editing content for the measurement value. Therefore, the measurement application software displays the marker M superimposed on the user interface for selecting the editing content displayed in the option panel R3, and places a notification display area R4 nearby to display the notification “Please confirm the edited content” (S16 in FIG. 8). In the example of FIG. 8, the marker M is displayed superimposed on the toggle switch SW for selecting whether to enable the setting of tolerance ranges as the measurement value edit content, and the notification display area R4 is displayed near the position where the user interface for editing each value of the tolerance range is displayed.

When the operator taps the toggle switch SW to enable setting the tolerance range, the upper and lower limits defining the tolerance range become editable. The recommended operation to be performed next in this state is to check the respective values of the tolerance range and edit them as necessary. Therefore, the measurement application software displays the marker M superimposed on each value of the tolerance range shown in the option panel R3 and on the confirmation button B1. Furthermore, the notification display area R4 is placed near each value of the tolerance range, and the notification “Please confirm the edited content” continues to be displayed (S17 in FIG. 8). As described, when indicating multiple operation locations with markers M, it is also possible to avoid placing the notification display area R4 near some of the operation locations.

When the operator edits each value of the tolerance range as needed and taps the confirmation button B1, the tolerance range for the measurement value is confirmed. The recommended operation to be performed next in this state is either saving the measurement result or extracting elements from the image again to include new measurement values in the measurement result. Therefore, the measurement application software displays the marker M superimposed on two icons IC related to the functions of extracting elements from among the icons displayed on toolbar R2, and on menu button B2 at the top of option panel R3. Then, the notification display area R4 is placed near the icons IC related to the function of extracting elements, and the notification “Extract the element” is displayed. Another notification display area R4 is placed near the menu button B2 and the notification “Save” is displayed (S18 in FIG. 8).

When the operator performs the operation to extract elements, a shape representing the extracted elements is displayed superimposed on the image of the measurement object W in the camera view R1, resulting in a state similar to S12. Thereafter, the operator continues the measurement operation until measurement values for all desired measurement points are included in the measurement results. During the operation, the notifications of recommended operations similar to those described in S12 to S18 above are issued in response to the operator's operations. On the other hand, if the operator selects the save command from the displayed menu when pressing the menu button B2, the measurement results are saved, and the series of measurement operations ends.

According to the notifications of recommended operations in the operation location indications described above, similar to the notification in the fixed location indications, the operator can intuitively understand that they should perform the operation at the location indicated by the marker M to execute the content notified in the notification display area R4. This allows even operators with limited knowledge of measurement operation methods to easily grasp the operation to be performed next. As a result, measurement operations can be performed efficiently. In addition, by concentrating information near the area to be operated, eye movement can be minimized, enabling efficient operation.

The present invention is not limited to the above embodiments and variations. The above-mentioned embodiments and variations are examples only, and anything having a configuration substantially the same as the technical idea described in the claims of the present invention and producing similar effects is included in the technical scope of the present invention. In other words, changes can be made as appropriate within the scope of the technical ideas expressed in the present invention, and forms with such changes and improvements are also included in the technical scope of the present invention.

With respect to the embodiments and modifications thereof, the following appendices are further disclosed.

### Appendix 1

An image measuring apparatus that captures an image of a measurement object and measures the dimensions of the measurement point of the measurement object by analyzing the image, comprising:
a display for displaying an image and a user interface of measurement application software used for image analysis; and
a processor that executes the measurement application software,
wherein the processor identifies an operation recommended to be performed next based on the processing state of the measurement application software, and causes the display to display a textual notification of the recommended operation and a marker indicating the location for the recommended operation on the screen of the measurement application software displayed on the display.

### Appendix 2

The image measuring apparatus according to Appendix 1, wherein the processor causes the textual notification of the recommended operation to be displayed at a predetermined location on the screen of the measurement application software, regardless of the processing state.

### Appendix 3

The image measuring apparatus according to Appendix 1, wherein the processor causes the textual notification of the recommended operation to be displayed in the vicinity of the marker indicating the operation location on the screen of the measurement application software.

### Appendix 4

The image measuring apparatus according to Appendix 1, wherein the processor is configured to be selectable between a first notification mode for displaying the textual notification at a predetermined position and a second notification mode for displaying the textual notification in the vicinity of the marker.

### Appendix 5

The image measuring apparatus according to Appendix 1, wherein the screen of the measurement application software displayed on the display includes a camera view displaying an image of the measurement object, and the processor causes a shape representing an element extracted by analyzing the image to be displayed on the camera view, and causes the marker to be displayed superimposed on the shape.

### Appendix 6

The image measuring apparatus according to Appendix 1, wherein when multiple elements are extracted by analyzing the image, the processor causes the marker to be displayed only on a limited number of elements selected based on predetermined conditions.

### Appendix 7

The image measuring apparatus according to Appendix 1, wherein when multiple recommended operations exist, the processor causes the marker to be displayed at the operation location corresponding to each of the operations.

### Appendix 8

The image measuring apparatus according to Appendix 1, wherein when the user selects a measurement value, the processor causes the textual notification and the marker recommending an editing operation to set a tolerance range for the selected measurement value to be displayed.

### Appendix 9

The image measuring apparatus according to Appendix 1, wherein the screen of the measurement application software displayed on the display includes a camera view displaying an image of the measurement object, and the processor causes the marker to be displayed superimposed at the position of the measurement value displayed in the camera view.

### Appendix 10

A computer-readable storage medium storing a program for causing a computer to perform as a processor of the image measuring apparatus as described in any one of Appendices 1 to 9 by executing a measurement application software.

1. An image measuring apparatus that captures an image of a measurement object and measures the dimensions of the measurement point of the measurement object by analyzing the image, comprising:
a display for displaying an image and a user interface of measurement application software used for image analysis; and
a processor for executing the measurement application software,
wherein the processor identifies an operation recommended to be performed next based on the processing state of the measurement application software, and causes the display to display a textual notification of the recommended operation and a marker indicating the location for the recommended operation on the screen of the measurement application software displayed on the display .

2. The image measuring apparatus according to claim 1, wherein the processor causes the textual notification to be displayed at a predetermined location on the screen of the measurement application software, regardless of the processing state.

3. The image measuring apparatus according to claim 1, wherein the processor causes the textual notification to be displayed in the vicinity of the marker indicating the operation location on the screen of the measurement application software.

4. The image measuring apparatus according to claim 1, wherein the processor is configured to be selectable between a first notification mode for displaying the textual notification at a predetermined position and a second notification mode for displaying the textual notification in the vicinity of the marker.

5. The image measuring apparatus according to claim 1, wherein the screen of the measurement application software displayed on the display includes a camera view displaying an image of the measurement object, and the processor causes a shape representing an element extracted by analyzing the image to be displayed on the camera view, and causes the marker to be displayed superimposed on the shape.

6. The image measuring apparatus according to claim 1, wherein when multiple elements are extracted by analyzing the image, the processor causes the marker to be displayed only on a limited number of elements selected based on predetermined conditions.

7. The image measuring apparatus according to claim 1, wherein when multiple recommended operations exist, the processor causes the marker to be displayed at the operation location corresponding to each of the operations.

8. The image measuring apparatus according to claim 1, wherein when the user selects a measurement value, the processor causes the textual notification and the marker recommending an editing operation to set a tolerance range for the selected measurement value to be displayed.

9. The image measuring apparatus according to claim 1, wherein the screen of the measurement application software displayed on the display includes a camera view displaying an image of the measurement object, and the processor causes the marker to be displayed superimposed at the position of the measurement value displayed in the camera view.

10. A computer-readable storage medium storing a program for causing a computer to perform as a processor of the image measuring apparatus as claimed in claim 1 by executing a measurement application software.
